(19) United States
(12) Patent Application Publication
(10) Pub. No.: US 2026/0194469 A1
(43) Pub. Date: Jul. 9, 2026

(54) ANALYZER APPARATUS

(71) Applicant: FUJIFILM CORPORATION, Tokyo (JP)

(72) Inventor: Yoshinobu MIURA, Kanagawa (JP)

(21) Appl. No.: 19/558,479

(22) Filed: Mar. 6, 2026

Related U.S. Application Data
(63) Continuation of application No. PCT/JP2024/029692, filed on Aug. 21, 2024.

(30) Foreign Application Priority Data
Sep. 21, 2023 (JP) 2023-156445

(51) Int. Cl. G01N 21/78

(52) U.S. Cl. CPC G01N 21/78

(57) ABSTRACT

An analyzer apparatus comprises: a photometric unit including a plurality of types of light-emitting elements arranged at different positions and configured to selectively irradiate a reactive region with light having different center wavelengths, and an area sensor captures an image of a predetermined image capturing range including the irradiated reactive region; a color plate arranged in the image capturing range; and a processor configured to calculate a concentration of a detection target substance based on a measurement value corresponding to luminance data of the reactive region extracted from the image, extract correction luminance data of the color plate from the image, and correct the measurement value with the correction luminance data, wherein the processor changes an extraction region for the correction luminance data according to a type of the light-emitting element that emits the light.

### CROSS-REFERENCE TO RELATED APPLICATIONS

This application is a continuation of International Application No. PCT/JP2024/029692, filed on August 21, 2024, which claims priority from Japanese Patent Application No. 2023-156445, filed on September 21, 2023. The entire disclosure of each of the above applications is incorporated herein by reference.

### BACKGROUND

### 1. Technical Field

The present disclosure relates to an analyzer apparatus.

### 2. Related Art

There has been known an analyzer apparatus that analyzes a test substance sample using an analytical chip on which the test substance sample is spotted. As the analysis of the test substance sample, measurement of the concentration of a detection target substance included in the test substance sample through measurement of a reaction state between the test substance sample and a reagent and the like are performed. Examples of the test substance sample include blood, urine, and the like. As the analytical chip, an analytical chip including a reactive region including a dry reagent is generally used.

In an analyzer apparatus, a reaction product produced by a reaction between a detection target object and a reagent is detected by irradiating the reactive region on which the test substance sample is spotted in the analytical chip with measurement light and detecting reflected light thereof. Therefore, the analyzer apparatus includes a photometric unit that irradiates the analytical chip with the measurement light and detects the reflected light.

JP1995-005110A (JP-H07-005110A) proposes an analyzer apparatus in which a reflecting piece serving as a reference is placed in the field of view of a detector, and the reflectance of a test piece is corrected by the reflectance of the reflecting piece, thereby correcting a change in sensitivity due to a change in the amount of light of a light source lamp or the like.

### SUMMARY

In an analyzer apparatus, in order to analyze a plurality of items (detection target substances), light having a wavelength suitable for each of the items is emitted. As a light source, one white light source and an optical filter capable of selecting a wavelength may be included, or a plurality of types of light-emitting elements that output light having different wavelengths may be included.

When the analyzer apparatus includes a plurality of types of light-emitting elements, the light-emitting elements are arranged at different positions as a matter of course. The light amount distribution of the light emitted by the light-emitting elements arranged at different positions is not uniform, and differs among the arrangement positions. JP1995-005110A (JP-H07-005110A) does not take into account the fact that a difference occurs in the light amount distribution due to the arrangement of a plurality of types of light-emitting elements at different positions when the sensitivity variation is corrected.

The technique of the present disclosure has been made in view of the above circumstances, and an object thereof is to provide an analyzer apparatus capable of performing analysis with high accuracy even when a plurality of types of light-emitting elements are included.

An analyzer apparatus according to the present disclosure is an analyzer apparatus in which an analytical chip including a reactive region where a reagent is held is detachably loaded, and a test substance sample spotted on the reactive region of the analytical chip is analyzed, the analyzer apparatus including:

a photometric unit configured to optically detect a color produced as a result of a reaction between the reagent and a detection target substance in the test substance sample, the photometric unit including a plurality of types of light-emitting elements arranged at different positions and configured to selectively irradiate the reactive region with light that have different center wavelengths, and an area sensor configured to capture an image of a predetermined image capturing range including the reactive region irradiated with the light from the light-emitting elements; a color plate arranged in the image capturing range and having a region irradiated with the light from all of the plurality of types of light-emitting elements; and

a processor configured to acquire the image from the photometric unit and calculate a concentration of the detection target substance based on a measurement value corresponding to luminance data of the reactive region extracted from the acquired image, the processor being configured to extract correction luminance data that is luminance data of the color plate from the image in addition to the luminance data of the reactive region and correct the measurement value with the correction luminance data, in which

the processor is configured to change an extraction region for the correction luminance data to be extracted from the image in accordance with a type of the light-emitting element that emits the light.

The analytical chip preferably includes a dry reagent as the reagent.

The color plate preferably has an optical density of 1.5 or less.

The color plate is preferably monochromatic.

With the analyzer apparatus of the technique of the present disclosure, it is possible to perform analysis with high accuracy even when a plurality of types of light-emitting elements are included.

### BRIEF DESCRIPTION OF THE DRAWINGS

FIG. 1 is a schematic diagram illustrating an overall configuration of an analyzer apparatus according to an embodiment;

FIG. 2 is a plan view of a main part of the analyzer apparatus illustrated in FIG. 1;

FIG. 3 is a cross-sectional view of a transportation path portion of an analytical chip;

FIG. 4 is a diagram illustrating an example of a configuration of the analytical chip;

FIG. 5 is a schematic diagram illustrating a schematic configuration of a photometric unit and a positional relationship of the analytical chip;

FIG. 6 is a perspective view illustrating a positional relationship among the analytical chip, a first light-emitting element group, a second light-emitting element group, and an area sensor;

FIG. 7 is a plan view of an irradiation device and the area sensor as viewed from a rotary substrate side;

FIG. 8 is an image captured by the area sensor;

FIG. 9 is a graph illustrating variations in measurement values not corrected by luminance data of a color plate among a plurality of measurements (Comparative Example); and

FIG. 10 is a graph illustrating variations in corrected measurement values after correction by luminance data of the color plate among a plurality of measurements (Example).

### DESCRIPTION OF EMBODIMENTS

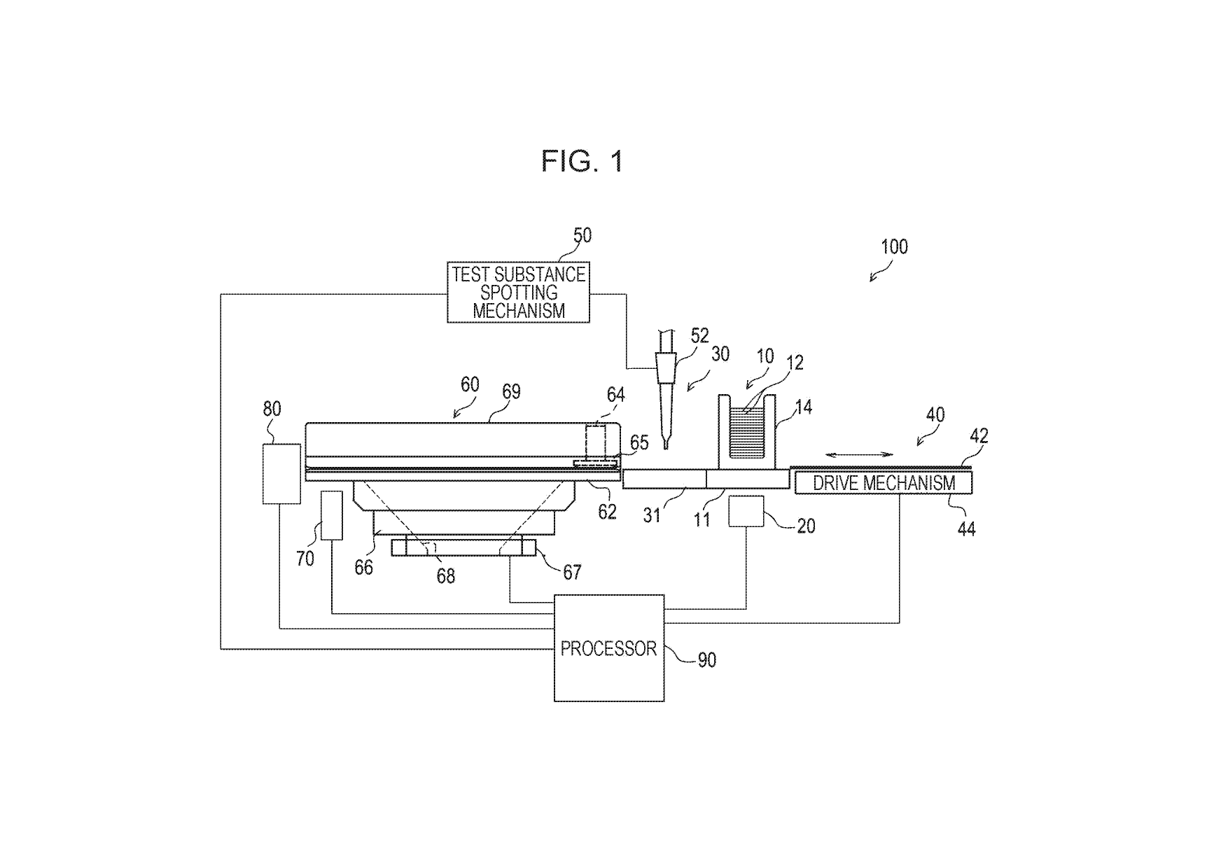

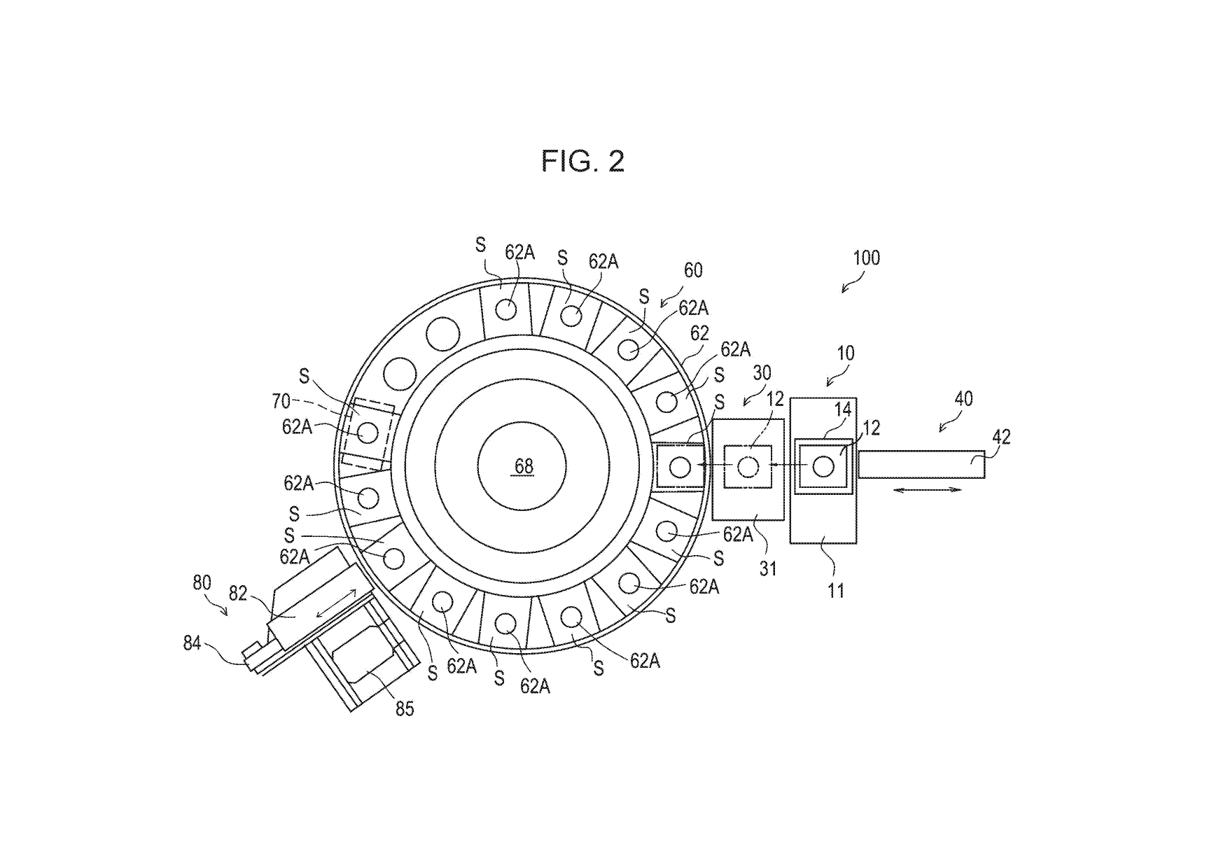

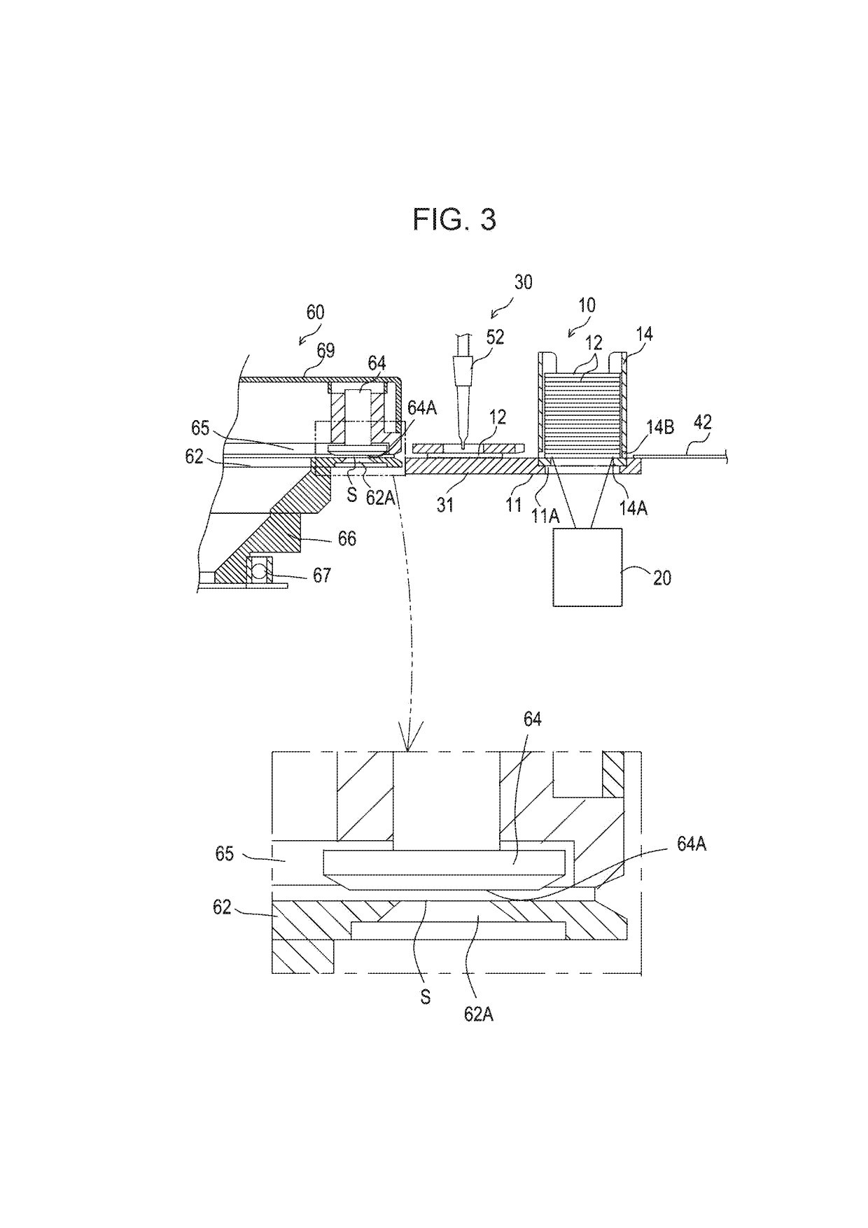

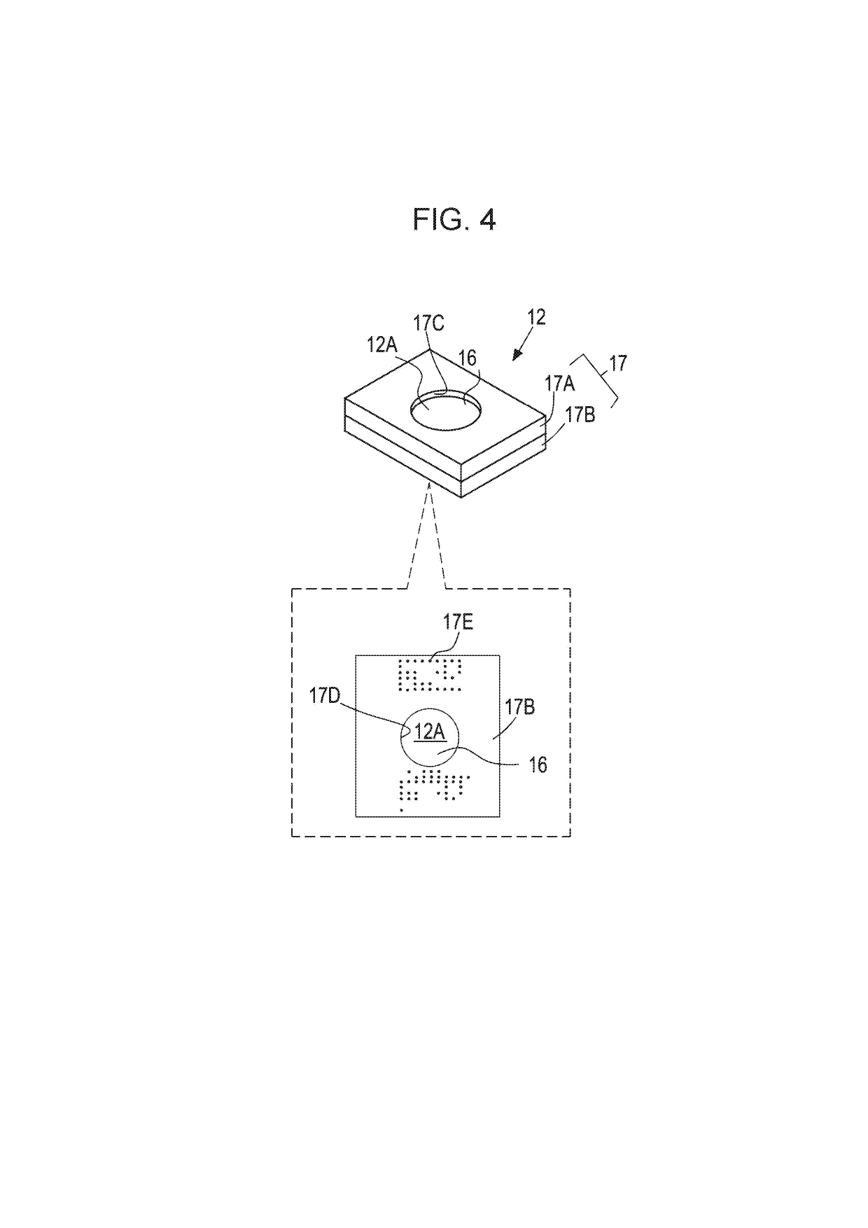

Preferred embodiments of the present disclosure will be described below with reference to the drawings. In the drawings, the same components are denoted by the same reference numerals. FIG. 1 is a schematic diagram illustrating an overall configuration of an analyzer apparatus 100 according to an embodiment. FIG. 2 is a plan view of a main part of the analyzer apparatus 100 illustrated in FIG. 1. FIG. 3 is a cross-sectional view of a transportation path portion of an analytical chip. FIG. 4 is a diagram illustrating an example of a configuration of the analytical chip.

The analyzer apparatus 100 illustrated in FIG. 1 is an example of an analyzer apparatus that analyzes a test substance sample. An analytical chip 12 is detachably loaded in the analyzer apparatus 100. In the analyzer apparatus 100, for example, the concentration of a detection target substance included in the test substance sample is measured using a dry analytical chip. The analyzer apparatus 100 of the present example uses blood as the test substance sample and optically measures the concentration of a detection target substance included in the blood. More specifically, the concentration of the detection target substance is measured by colorimetry.

The analyzer apparatus 100 includes a chip set section 10, a reader 20, a test substance spotting unit 30, a chip transportation mechanism 40, a test substance spotting mechanism 50, an incubator 60, a photometric unit 70, a chip discarding mechanism 80, and a processor 90.

In the chip set section 10, a stocker 14 for accommodating the analytical chip 12 is disposed on a holding table 11. A plurality of the analytical chips 12 are stacked and accommodated in the stocker 14.

The reader 20 is, for example, a code reader that reads item information given to the analytical chip 12. Thus, the type, the lot number, and/or the like of the analytical chip 12 is/are identified. The reader 20 includes, for example, an image sensor such as a charge coupled device (CCD) and a complementary metal oxide semiconductor (CMOS). The item information read by the reader 20 is output to the processor 90.

In the test substance spotting unit 30, a test substance sample including a test substance such as blood plasma, whole blood, serum, or urine is spotted on the analytical chip 12. The test substance spotting unit 30 is provided with a chip support table 31, and spotting of the test substance sample on the analytical chip 12 transported on the chip support table 31 is performed on the chip support table 31. The spotting of the test substance sample is performed by the test substance spotting mechanism 50 described below. The chip support table 31 is disposed adjacent to the holding table 11.

As illustrated in FIG. 1 and FIG. 2, the chip transportation mechanism 40 transports the analytical chip 12 from the chip set section 10 to the test substance spotting unit 30, and further from the test substance spotting unit 30 to the incubator 60. The chip transportation mechanism 40 includes a thin plate-like chip transportation member 42, and a drive mechanism 44 that moves the chip transportation member 42 back and forth in an arrangement direction of the chip set section 10, the test substance spotting unit 30, and the incubator 60. The drive mechanism 44 is, for example, a linear actuator. The chip transportation member 42 is slidably supported by a guide rod (not illustrated) and is moved back and forth by the drive mechanism 44.

As illustrated in FIG. 1, the test substance spotting mechanism 50 includes a nozzle 52, a suction/discharge mechanism (not illustrated), and a movement mechanism that moves the nozzle 52. The test substance spotting mechanism 50 sucks a test substance sample from a test substance sample container (not illustrated) and spots the test substance sample on the analytical chip 12 in the test substance spotting unit 30.

The incubator 60 can accommodate the plurality of analytical chips 12 therein. The incubator 60 has a thermostatic function of maintaining a constant temperature in order to promote the reaction between the reagent and the test substance sample in the analytical chip 12. The set temperature is, for example, 37°C or the like.

As illustrated in FIG. 2, the incubator 60 includes an annular rotary substrate 62 provided with a plurality of cells S in which the analytical chips 12 are loaded. A disk-shaped holding member 65 having a pressing member 64 for pressing the analytical chips 12 loaded in the cells S in a direction toward a reactive region 12A (see FIG. 4) is included above the rotary substrate 62. The pressing member 64 is included corresponding to each of the plurality of cells S. As illustrated in FIG. 3, in the incubator 60, a slit-shaped space where the analytical chip 12 is loaded is formed between a pressing surface 64A of the pressing member 64 and the cell S.

A rotary cylinder 66 is provided below the rotary substrate 62. The rotary cylinder 66 has a substantially inverted triangular cross-sectional shape with the inner diameter decreasing toward the lower side. A bearing 67 is disposed below an outer circumference of the rotary cylinder 66, and the rotary cylinder 66 is rotatably supported by the bearing 67. The rotary substrate 62 rotates with the rotation of the rotary cylinder 66. The holding member 65 rotates integrally with the rotary substrate 62. The rotary cylinder 66 has an opening in a bottom portion, which is a vertex portion of the inverted triangle. This opening functions as a discarding hole 68 for discarding the used analytical chip 12. The used analytical chip 12 in a state of being loaded in the cell S is moved toward the center side of the annular rotary substrate 62, and is dropped toward the inclined surface of the rotary cylinder 66. The used analytical chip 12 dropped into the rotary cylinder 66 slides on the inclined surface and is discarded through the discarding hole 68.

The holding member 65 is provided with heating means such as a heater (not illustrated) that performs temperature adjustment to constantly maintain the analytical chip 12 accommodated in the cell S at a predetermined temperature. A heat insulating cover 69 is arranged on the upper surface of the holding member 65. FIG. 2 illustrates a state where the holding member 65 and the heat insulating cover 69 are removed to expose the rotary substrate 62.

As illustrated in FIG. 2, an opening window 62A for photometry is formed at the center of the bottom surface of each cell S of the rotary substrate 62, and colorimetry for the analytical chip 12 is performed through this opening window 62A by the photometric unit 70 disposed below the rotary substrate 62.

The photometric unit 70 performs colorimetry, which is measurement for optical density using a colorimetric method, on the analytical chip 12. The photometric unit 70 is provided below the rotary substrate 62 in an outer circumference portion of the incubator 60. The photometric unit 70 acquires a detection signal indicating the optical density of the reactive region 12A of the analytical chip 12, and outputs the detection signal to the processor 90. The photometric unit 70 includes a plurality of types of light-emitting elements and an area sensor. The photometric unit 70 is an embodiment of a photometric device of the present disclosure. Details of the photometric unit 70 will be described below.

The analyzer apparatus 100 further includes a color plate 75 disposed in the image capturing range of the area sensor. The color plate 75 has a region irradiated with light from all of the plurality of types of light-emitting elements.

The chip discarding mechanism 80 includes a thin plate-like chip transportation member 82 and a drive mechanism 84 that moves the chip transportation member 82 back and forth. The chip discarding mechanism 80 inserts the chip transportation member 82 into the cell S from the outer circumference portion of the incubator 60, and pushes out the used analytical chip 12 after the measurement toward the central portion of the incubator 60. Thus, the analytical chip 12 is dropped into the discarding hole 68. The drive mechanism 84 is, for example, a linear actuator. The chip transportation member 82 is slidably supported by a guide rod (not illustrated) and is moved back and forth by the drive mechanism 84. A collection box for collecting the used analytical chip 12 is disposed below the discarding hole 68.

The processor 90 comprehensively controls each part of the analyzer apparatus 100. The configuration of the processor 90 is not particularly limited. For example, the processor 90 includes a central processing unit (CPU), a non-volatile memory (NVM), a random access memory (RAM), and the like, and executes a measurement process in the analyzer apparatus 100 by executing a program. The processor 90 obtains the concentration of the detection target substance included in the test substance sample based on the detection signal acquired from the photometric unit 70. Specifically, the optical density is obtained from the reflected light amount value of the reactive region 12A, and the concentration of the detection target substance is obtained based on the calibration curve indicating the relationship between the optical density and the concentration of the detection target substance. In addition to the luminance data of the reactive region 12A, the processor 90 extracts correction luminance data, which is the luminance data of the color plate 75, from the image, and corrects the measurement value with the correction luminance data. The processor 90 also changes an extraction region for the correction luminance data to be extracted from the image in accordance with a type of the light-emitting element that emits the light.

As illustrated in FIG. 4, the analytical chip 12 has the reactive region 12A, having a flat shape, on which a reagent is immobilized. When the reagent reacts with the detection target substance, a substance that develops a specific color is generated. The substance that develops the color through the reaction is hereinafter referred to as a reactant. As the reagent, for example, a dry reagent, which is in a dry state at least at the time of shipment, is used. The test substance sample is spotted on the reactive region 12A of the analytical chip 12.

The analytical chip 12 has a carrier 16 on which the test substance sample is spotted, and the carrier 16 is accommodated in a case 17. The case 17 includes a first case 17A and a second case 17B, and the carrier 16 is accommodated while being sandwiched between the first case 17A and the second case 17B. The first case 17A has an opening 17C formed to function as a dropping port through which the test substance sample is spotted on the reactive region 12A. An opening 17D for irradiating the reactive region 12A with light is formed in the second case 17B. The carrier 16 is exposed through the opening 17C of the first case 17A forming the front surface of the analytical chip 12. The carrier 16 is also exposed through the opening 17D of the second case 17B forming the back surface of the analytical chip 12. A region of the carrier 16 exposed through the opening 17D serves as the reactive region 12A on which the reagent is immobilized. In addition, the second case 17B is provided with an information code 17E in which item information related to a measurement item is encoded. The information code 17E is, for example, a pattern in which a plurality of dots arranged are arranged, and the dot arrangement pattern is different among measurement items. Of course, as the information code 17E, a one-dimensional barcode, a two-dimensional barcode, or the like may be used.

By preparing a plurality of the analytical chips 12 having different types of reagents to be reacted with the test substance sample, it is possible to analyze a plurality of measurement items for the test substance sample. The analytical chip 12 is prepared for each measurement item, and the carrier 16 for holding a reagent corresponding to the measurement item is immobilized on the analytical chip 12. The item information provided to each analytical chip 12 includes identification information (such as reagent name and identification code) of a reagent immobilized on the carrier 16 of the analytical chip 12, identification information (such as item name and identification code) of the measurement item measured using the reagent, and the like.

As illustrated in FIG. 3, the stocker 14 has a sidewall provided with an insertion port 14B into which the chip transportation member 42 is inserted. The chip transportation member 42 is inserted into the stocker 14 through the insertion port 14B.

The stocker 14 has a bottom surface provided with an opening 14A. The analytical chip 12 accommodated in the stocker 14 is oriented to have a surface on which the information code 17E is recorded, facing the opening 14A side of the stocker 14. Therefore, in the stocker 14, the information code 17E of the analytical chip 12 positioned at the lowest stage closest to the opening 14A is exposed through the opening 14A. The holding table 11 on which the stocker 14 is disposed is also provided with an opening 11A. Therefore, the information code 17E of the analytical chip 12 positioned at the lowest stage in the stocker 14 is exposed toward the reader 20 through the opening 11A of the holding table 11 and the opening 14A of the stocker 14. The reader 20 is disposed below the holding table 11 and reads the information code 17E exposed through the opening 11A and the opening 14A.

The chip transportation member 42 is pressed against the analytical chip 12 accommodated in the lowest stage among the analytical chips 12 stacked in the stocker 14. In this state, the chip transportation member 42 moves toward the incubator 60 side. As a result, the analytical chip 12 is transported toward the incubator 60 side.

In the incubator 60, the analytical chip 12 is loaded in the slit-shaped space formed between the cell S of the rotary substrate 62 and the pressing member 64. The analytical chip 12 is heated in the incubator 60 and is transported to a measurement position by the rotation of the incubator 60. The measurement position is a position where the photometric unit 70 is disposed below the rotary substrate 62 and the colorimetry is performed on the analytical chip 12.

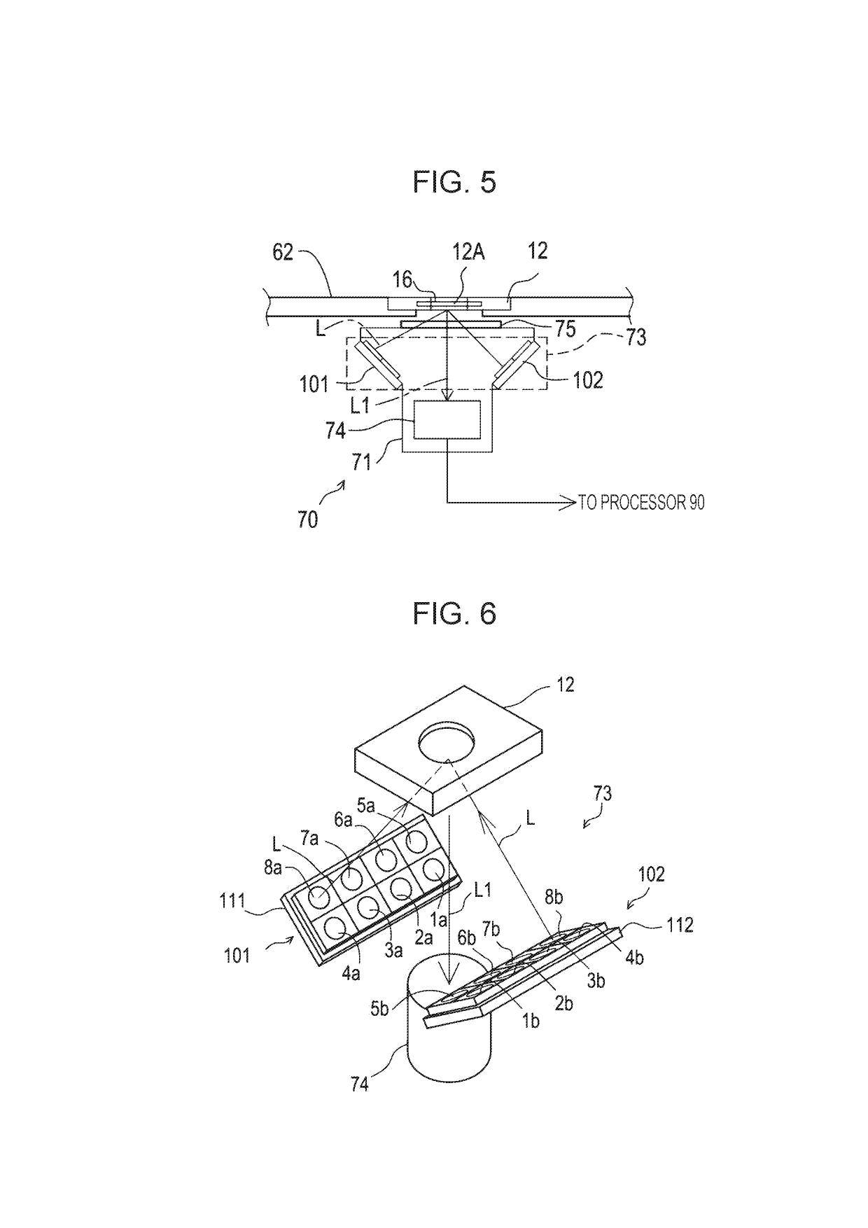

FIG. 5 is a schematic diagram illustrating a schematic configuration of the photometric unit 70 and a positional relationship of the analytical chip 12. As illustrated in FIG. 5, the photometric unit 70 includes a housing 71, an irradiation device 73 for irradiating the reactive region 12A with measurement light L, and an area sensor 74 that captures an image of the reactive region 12A. The housing 71 includes therein an optical system (not illustrated) for collecting reflected light L1 from the reactive region 12A and guiding the light to the area sensor 74.

As will be described in detail below, the irradiation device 73 includes two light-emitting element groups 101 and 102 each including a plurality of light-emitting elements. The wavelength range of the measurement light L is determined according to the detection target substance (that is, measurement item). For example, in the present example, as described above, a reactant that develops a specific color is generated as a result of the reaction between the detection target substance and the reagent. Since the irradiation light from the irradiation device 73 is the measurement light L for detecting whether the reactant is generated, the wavelength range is determined according to the color developed by the reactant. The measurement light L of the present example is, for example, light including a wavelength range to be absorbed by the reactant, for the detection of the reactant. A plurality of light-emitting elements 1a to 8a (see FIG. 6) included in the light-emitting element group 101 emit light having different center wavelengths. A plurality of light-emitting elements 1b to 8b (see FIG. 6) included in the light-emitting element group 102 emit beams of the measurement light L having different center wavelengths. Each light-emitting element is used in accordance with the type of the analytical chip 12, that is, the measurement item.

The wavelength range of the measurement light L is preferably limited to a wavelength range to be absorbed by the reactant. As the light-emitting elements 1a to 8a and 1b to 8b that emit the measurement light L, for example, light-emitting diodes (LEDs), organic electro luminescence (ELs), semiconductor lasers, or the like are used.

When the analytical chip 12 is irradiated with the measurement light L, the area sensor 74 captures an image of a predetermined image capturing range including the reactive region 12A of the analytical chip 12. The area sensor 74 is an area sensor, and is for example, an image sensor such as a CCD camera or a CMOS camera. The area sensor 74 outputs the captured image to the processor 90 (see FIG. 1).

The analysis in the analyzer apparatus 100 is performed as follows.

First, the analytical chip 12 is taken out from the stocker 14 by the chip transportation mechanism 40, and then transported to a spotting position on the chip support table 31. At the spotting position, the test substance is spotted on the analytical chip 12 by the test substance spotting unit 30. After the spotting on the analytical chip 12, the analytical chip 12 is transported into the incubator 60.

After the analytical chip 12 is transported into the incubator 60, the analytical chip 12 is heated by heat generated by heating means (not illustrated) in the incubator 60.

The analytical chip 12 as the measurement target is transported to the measurement position where the photometric unit 70 is included, by the rotation of the rotary substrate 62. At the measurement position, measurement using the colorimetric method is performed on the analytical chip 12. The photometric unit 70 irradiates the analytical chip 12 with the measurement light L and receives the reflected light L1 from the analytical chip 12 to measure an optical density corresponding to a state of reaction between the test substance sample and the reagent in the analytical chip 12, and outputs a detection signal. The processor 90 obtains the concentration of the detection target substance from the detection signal acquired from the photometric unit 70.

In the reactive region 12A, the test substance sample and the reagents react with each other. As a result, the reactant that develops a specific color is generated. Due to the generation of the reactant, the color of the reactive region 12A changes, and this color change appears as a change in the optical density of the reactive region 12A. The reflected light L1 is light corresponding to the optical density of the reactive region 12A, and the reflected light L1 reflects information of the reactant as a result of absorption of light by the reactant or the like. The optical density of the reactive region 12A changes according to the amount of the reactant, and the amount of the reactant represents the concentration of the detection target substance in the test substance sample. Therefore, the concentration of the detection target substance can be measured based on the detection signal indicating the reflected light L1 including the information of the reactant.

After the measurement is completed, the analytical chip 12 is transported by the rotary substrate 62 to a position where the chip discarding mechanism 80 is disposed. Thereafter, the analytical chip 12 is transported by the chip discarding mechanism 80 (see FIG. 2) from the inside of the incubator 60 to a discarding position provided at the central portion of the rotary substrate 62. The chip transportation member 82 pushes out the analytical chip 12, to move the analytical chip 12 from the inside of the incubator 60 to the discarding hole 68.

Hereinafter, the photometric unit 70 will be described in detail.

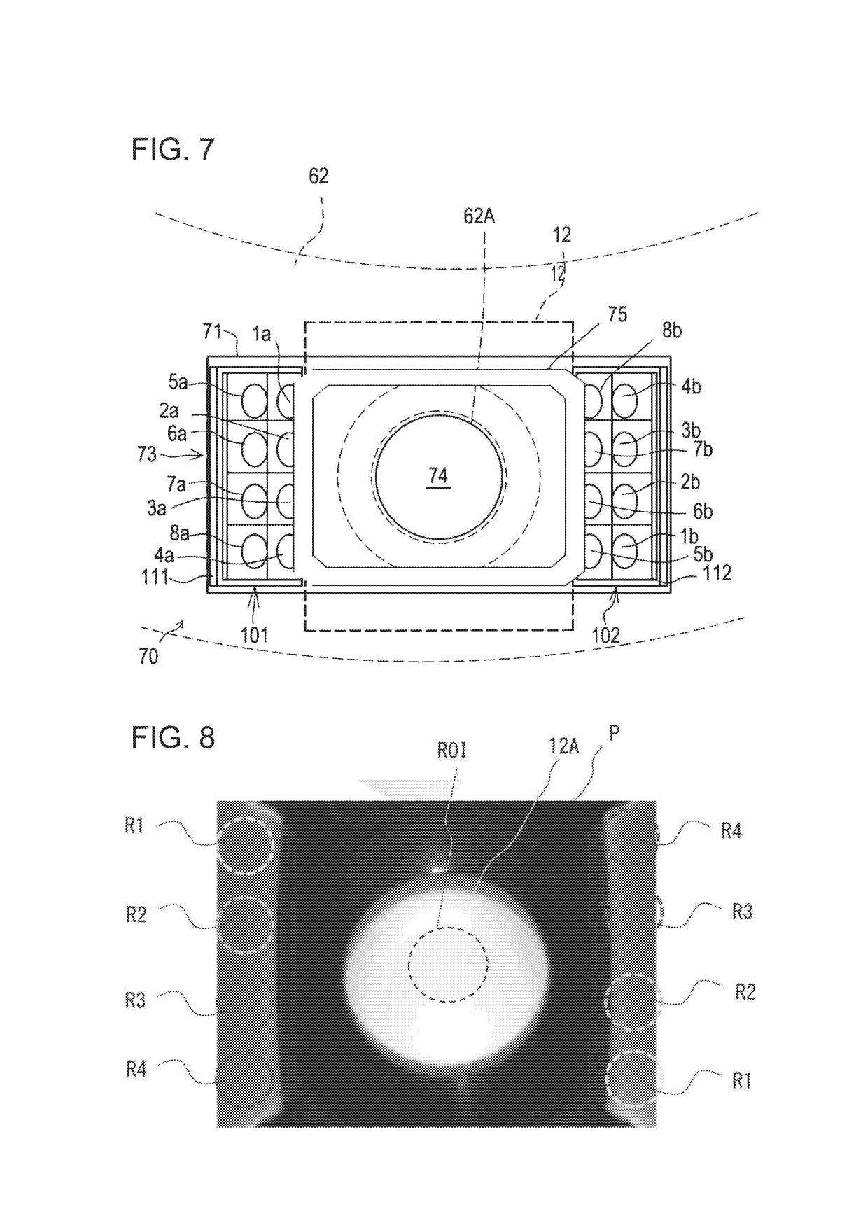

As described with reference to FIG. 5, the irradiation device 73 includes the two light-emitting element groups 101 and 102. Hereinafter, one of the two light-emitting element groups 101 and 102 is referred to as a first light-emitting element group 101, and the other is referred to as a second light-emitting element group 102. FIG. 6 is a perspective view illustrating a positional relationship among the analytical chip 12, the first light-emitting element group 101, the second light-emitting element group 102, and the area sensor 74 illustrated in FIG. 5. In FIG. 6, the color plate 75 is omitted. FIG. 7 is a plan view of the color plate 75, the irradiation device 73, and the area sensor 74 as viewed from the rotary substrate 62 side.

As illustrated in FIG. 6, the first light-emitting element group 101 includes the eight light-emitting elements 1a to 8a on a support substrate 111, and the second light-emitting element group 102 includes the eight light-emitting elements 1b to 8b on a support substrate 112. As illustrated in the plan view of FIG. 7, the first light-emitting element group 101 and the second light-emitting element group 102 are disposed opposite to each other with the area sensor 74 interposed therebetween in plan view. The first light-emitting element group 101 and the second light-emitting element group 102 are disposed with the respective support substrates 111 and 112 inclined with respect to the normal line of the analytical chip 12. On the support substrates 111 and 112, the eight light-emitting elements 1a to 8a and the eight light-emitting elements 1b to 8b, respectively, are arranged in two rows. On the support substrate 111, light-emitting elements 8a, 7a, 6a, and 5a are arranged on the first row, on the rotary substrate 62 side, in this order from the outer circumference side of the rotary substrate 62, and light-emitting elements 4a, 3a, 2a, and 1a are arranged on the second row in this order from the outer circumference side of the rotary substrate 62. On the other hand, on the support substrate 112, light-emitting elements 1b, 2b, 3b, and 4b are arranged on the first row, on the rotary substrate 62 side, in this order from the outer circumference side of the rotary substrate 62, and light-emitting elements 5b, 6b, 7b, and 8b are arranged on the second row in this order from the outer circumference side of the rotary substrate 62.

As described above, the eight light-emitting elements 1a to 8a of the first light-emitting element group 101 emit light in different wavelength ranges. Similarly, the eight light-emitting elements 1b to 8b of the second light-emitting element group 102 emit light in different wavelength ranges. Hereinafter, the light-emitting elements of the first light-emitting element group 101 are referred to as first light-emitting elements 1a, 2a, 3a, ..., and the light-emitting elements of the second light-emitting element group 102 are referred to as second light-emitting elements 1b, 2b, 3b, ... In the present example, the first light-emitting element 1a and the second light-emitting element 1b, the first light-emitting element 2a and the second light-emitting element 2b, and the like with the same numbers, emit light in the same wavelength range. That is, the irradiation device 73 includes eight pairs of light-emitting elements that emit light of the same wavelength. It should be noted that the light in the same wavelength range refers to beams of light whose center wavelengths match within a range of ±5 nm, and beams of light whose wavelengths match within a range of ± 5 nm are referred to as light of the same wavelength.

At the time of measurement of one analytical chip 12, one light-emitting element pair consisting of two light-emitting elements having the same light emission center wavelength corresponding to the analytical chip 12 is selectively used among the first light-emitting elements 1a to 8a of the first light-emitting element group 101 and the second light-emitting elements 1b to 8b of the second light-emitting element group 102.

As described above, the color plate 75 is disposed in the image capturing range of the area sensor 74. As illustrated in FIG. 7, in the present example, the color plate 75 is a rectangular member and has a rectangular opening. Note that "the color plate 75 is disposed in the image capturing range of the area sensor 74" does not mean that the entire color plate 75 is disposed within the image capturing range, but means that the color plate 75 is at least partially disposed in the image capturing range.

FIG. 8 illustrates an image P captured by the area sensor 74. The outline of a circular portion at the center is the outline of the opening window 62A of the rotary substrate 62, and the inside of the circular portion is the reactive region 12A of the analytical chip 12 observed from the opening window 62A. The color plate 75 is members located on both sides of the image P and colored in gray.

The processor 90 acquires the image P from the area sensor 74 of the photometric unit 70. The processor 90 calculates the concentration of the detection target substance based on the measurement value corresponding to the luminance data of the reactive region 12A extracted from the acquired image P. The processor 90 of the present embodiment extracts, in addition to the luminance data of the reactive region 12A, correction luminance data that is luminance data of the color plate 75 from the image P, and corrects the measurement value using the correction luminance data. The processor 90 changes the extraction region for the correction luminance data to be extracted from the image P according to the type of the light-emitting elements that emit the measurement light L at the time of acquiring the image P. For example, the extraction region is set in a manner such that when the image P is obtained by irradiating the reactive region 12A of the analytical chip 12 with the measurement light L from the first light-emitting element 1a and the second light-emitting element 1b, regions R1 in the color plate 75 of the image P serve as the extraction regions for the correction luminance data, and when the image P is obtained by irradiating the reactive region with the measurement light L from the first light-emitting element 2a and the second light-emitting element 2b, regions R2 in the color plate 75 of the image P serve as the extraction regions for the correction luminance data. In the present example, when the image P is obtained by irradiating the reactive region 12A of the analytical chip 12 with the measurement light L from the first light-emitting element 3a and the second light-emitting element 3b, regions R3 in the color plate 75 of the image P serve as the extraction regions for the correction luminance data, and when the image P is obtained by irradiating the reactive region with the measurement light L from the first light-emitting element 4a and the second light-emitting element 4b, regions R4 in the color plate 75 of the image P serve as the extraction regions for the correction luminance data. Note that the positional relationships among the pairs of the light-emitting elements 5a and 5b, 6a and 6b, 7a and 7b, and 8a and 8b are the same as the positional relationships among the pairs of the light-emitting elements 1a and 1b, 2a and 2b, 3a and 3b, and 4a and 4b. Therefore, in the present example, the extraction regions for the correction luminance data for the pairs of light-emitting elements 5a and 5b, 6a and 6b, 7a and 7b, and 8a and 8b are the regions R1, R2, R3, and R4, respectively.

In the present example, for example, in a case where the measurement light L is emitted using the first light-emitting element 1a and the second light-emitting element 1b, in the light amount distribution of the emitted measurement light L on the color plate 75, the light amount around the region R1 is larger than in the other regions. In addition, for example, in a case where the measurement light L is emitted using the first light-emitting element 2a and the second light-emitting element 2b, in the light amount distribution of the emitted measurement light L on the color plate 75, the light amount around the region R2 is larger than in the other regions. As described above, in the present example, when the correction luminance data is extracted from the color plate 75, it is preferable to use a region in which the irradiation amount of the measurement light L emitted is as large as possible for each light-emitting element used for irradiation.

A method of obtaining the concentration of the detection target substance by the processor 90 when the image P is obtained by irradiating the reactive region 12A of the analytical chip 12 with the measurement light L from the light-emitting elements 1a and 1b will be described.

For example, the processor 90 uses the central portion of the reactive region 12A illustrated in FIG. 8 as a region of interest ROI, and obtains an average value A of the luminance data in this range as the measurement value. Then, the two regions R1 are used as the extraction regions for the correction luminance data, and an average value B of the correction luminance data, which is the luminance data in this range, is obtained as a correction value. Then, the processor 90 obtains, as a corrected measurement value, a value A/B by dividing the average value of the luminance data of the ROI by the correction luminance data. Then, the processor 90 obtains the concentration value of the detection target substance from the calibration curve based on this corrected measurement value.

The processor 90 obtains the concentration value of the detection target substance by the above-described procedure using any of the regions R1 to R4 as the extraction region for extraction of the correction luminance data as described above for each of the light-emitting elements that emit light when the image P is captured.

In an apparatus capable of measuring a plurality of types of analytical chips having different reagents for detecting different detection target substances, such as the analyzer apparatus 100, since light having different center wavelengths are selectively emitted for the respective analytical chips, a plurality of types of light-emitting elements are selectively turned on. In the analyzer apparatus 100, the temperature of the light-emitting elements turned on varies depending on the turn on timing, the number of times turned on, and the like. The amount of light emitted from the light-emitting elements may vary depending on the temperature. Specifically, for example, when the light-emitting elements are LEDs, the amount of light decreases as the temperature increases, and the amount of light increases as the temperature decreases. Therefore, even when the concentrations of the detection target substances are the same, the optical density of the reactive region 12A may vary depending on the turn on timing, the number of times turned on, and the like of the light-emitting elements. In the analyzer apparatus 100 of the present embodiment, the color plate 75 is included in the image capturing range of the area sensor 74, and the luminance data of the reactive region 12A in the image P is corrected with the correction luminance data, which is the luminance data of the color plate 75. Since normalization is performed using the luminance data of the color plate 75, it is possible to suppress variation in the measurement value due to variation in the amount of light emitted from the light-emitting elements. As a result, the accuracy of the concentration value of the detection target substance can be increased.

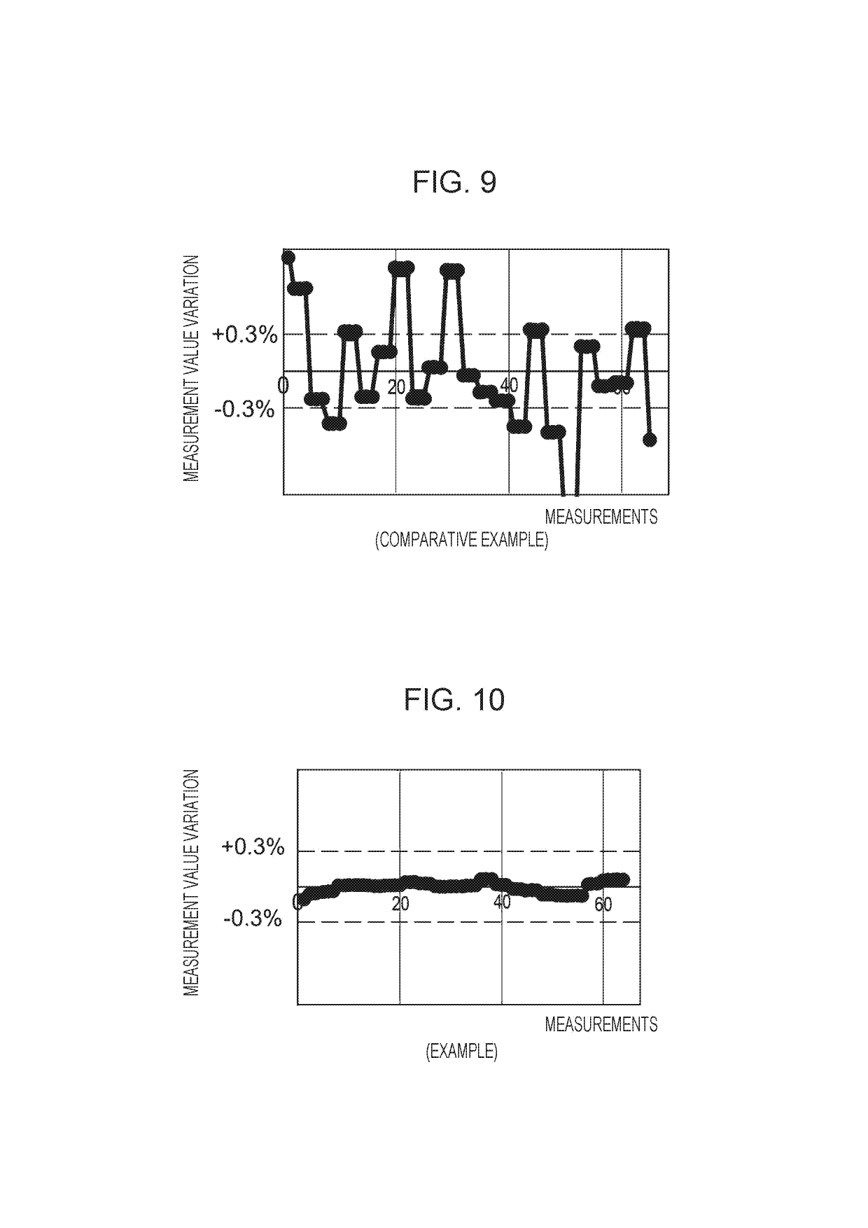

FIG. 9 illustrates a result (comparative example) of irradiating a test chip having a constant optical density with the measurement light L from the same light-emitting element a plurality of times (65 times), capturing an image with a CMOS sensor as the area sensor, and obtaining a measurement value that is an average value of luminance data of the region of interest ROI of the reactive region 12A. FIG. 10 illustrates a corrected measurement value (Example) obtained by normalizing the measurement value obtained in FIG. 9 using the average value of the luminance data of a specific region of the color plate 75. In FIGS. 9 and 10, the horizontal axis represents the number of measurements, and the vertical axis represents the variation from the average of the measurement values of all 65 times of the respective measurements. As illustrated in FIGS. 9 and 10, the measurement values before correction have a variation exceeding ±1%, but the variation for the measurement values after the correction can be reduced to about ±0.3%.

In the analyzer apparatus 100, when the correction luminance data is extracted from the color plate 75, a region in which the irradiation amount of the measurement light L emitted is as large as possible is used for each light-emitting element used for irradiation. The light amount distribution of the irradiation light on the color plate changes depending on the arrangement position of the light-emitting element. As in the present example, a measurement result with higher accuracy can be obtained by using luminance data of a region with a large light amount.

In the present example, the color plate 75 is a single member, but the color plate 75 may be composed of a plurality of members. The optical density of the color plate 75 is preferably 1.5 or less, and more preferably 1.0 or less, that is, the reflectance is 10% or more. The color plate 75 is preferably gray or white. This is because the correction accuracy increases with a larger reflected light amount and with a higher luminance value of the color plate in the image P captured by the area sensor 74.

In the present example, the color plate 75 is monochromatic, but may have a region of a plurality of colors, or may have a gradation of light and shade. In a case where the color plate 75 has a region of a plurality of colors, the processor 90 preferably uses a region of a color achieving a larger reflected light amount for the measurement light L having the light emission center wavelength of the light-emitting element, as the extraction region for the correction luminance data, according to the type of the light-emitting element.

In the photometric unit 70 of the analyzer apparatus 100, the irradiation device 73 includes two light-emitting elements that emit light in the same wavelength range, but the number of light-emitting elements that emit light in the same wavelength range may be one or three or more.

In the present example, the color plate 75 is used to correct the luminance data of the reactive region 12A of the analytical chip 12. The luminance data of the color plate 75 can also be used to detect a failure of the light-emitting elements 1a to 8a and 1b to 8b. For example, the processor 90 acquires the image P at the time of emission of the measurement light L for each type of the light-emitting elements, and acquires the luminance value of a predetermined part for each type of the light-emitting elements. The processor 90 stores the luminance value of the part obtained with the light-emitting element normally turned on as a reference luminance value in a memory or the like, and compares the luminance value at the time of measurement with this reference luminance value. The processor 90 may be configured to issue an alert indicating that there is a possibility that the light-emitting element has failed when the difference between the luminance values is equal to or greater than a certain value.

Further, in the above-described embodiment, as a hardware structure of the processor 90, various processors described below can be used. The various processors include, in addition to CPUs, which are general-purpose processors functioning as various processing units by executing software (programs), programmable logic devices (PLDs) such as a field programmable gate array (FPGA) whose circuit configuration can be changed after manufacture, dedicated electric circuits such as an application specific integrated circuit (ASIC), which are processors having a circuit configuration designed exclusively for executing specific processing, and the like.

In addition, the above-described processing may be executed by one of these various processors, or may be executed by a combination of two or more processors of the same type or different types (for example, a plurality of FPGAs, a combination of a CPU and an FPGA, or the like). In addition, a plurality of processing units may be configured with one processor. As an example of configuring a plurality of processing units with one processor, a mode may be employed in which a processor is used that realizes the functions of the entire system including a plurality of processing units with one integrated circuit (IC) chip, such as a system on chip (SOC).

Further, as a hardware structure of these processors, more specifically, an electric circuit (circuitry) in which circuit elements such as semiconductor elements are combined can be used.

In addition, the technique of the present disclosure also covers a computer-readable storage medium (such as a USB memory or a digital versatile disc (DVD)-read only memory (ROM)), which non-transitorily stores an operation program of the analyzer apparatus, in addition to the operation program of the analyzer apparatus.

It should be noted that the contents described and illustrated above are detailed descriptions of portions related to the technique of the present disclosure, and are merely examples of the technique of the present disclosure. For example, the description related to the configuration, the function, the operation, and the effect is a description related to an example of a configuration, a function, an operation, and an effect of a part according to the technique of the present disclosure. Therefore, it is a matter of course that unnecessary parts may be deleted, new elements may be added, or replacement may be made on the contents described and illustrated above without departing from the gist of the technique of the present disclosure. In addition, in order to avoid complexity and to facilitate understanding of a part related to the technique of the present disclosure, in the contents described and illustrated above, description related to technical common sense or the like, which does not particularly require description for enabling implementation of the technique of the present disclosure, is omitted.

The disclosure of JP2023-156445 filed on September 21, 2023 is incorporated herein by reference in its entirety. All publications, patent applications, and technical standards mentioned in this specification are herein incorporated by reference to the same extent as if each individual publication, patent application, or technical standard is specifically and individually indicated to be incorporated by reference.

What is claimed is:

1. An analyzer apparatus in which an analytical chip including a reactive region where a reagent is held is detachably loaded, and a test substance sample spotted on the reactive region of the analytical chip is analyzed, the analyzer apparatus comprising:
a photometric unit configured to optically detect a color produced as a result of a reaction between the reagent and a detection target substance in the test substance sample, the photometric unit including a plurality of types of light-emitting elements arranged at different positions and configured to selectively irradiate the reactive region with light that have different center wavelengths, and an area sensor configured to capture an image of a predetermined image capturing range including the reactive region irradiated with the light from the light-emitting elements;
a color plate arranged in the image capturing range and having a region irradiated with the light from all of the plurality of types of light-emitting elements; and
a processor configured to acquire the image from the photometric unit and calculate a concentration of the detection target substance based on a measurement value corresponding to luminance data of the reactive region extracted from the acquired image, the processor being configured to extract correction luminance data that is luminance data of the color plate from the image in addition to the luminance data of the reactive region and correct the measurement value with the correction luminance data, wherein
the processor is configured to change an extraction region for the correction luminance data to be extracted from the image in accordance with a type of the light-emitting element that emits the light.

2. The analyzer apparatus according to claim 1, wherein the analytical chip includes a dry reagent as the reagent.

3. The analyzer apparatus according to claim 1, wherein the color plate has an optical density of 1.5 or less.

4. The analyzer apparatus according to claim 2, wherein the color plate has an optical density of 1.5 or less.

5. The analyzer apparatus according to claim 1, wherein the color plate is monochromatic.

6. The analyzer apparatus according to claim 2, wherein the color plate is monochromatic.
